(19) United States
(12) Patent Application Publication
(10) Pub. No.: US 2002/0104160 A1
(43) Pub. Date: Aug. 8, 2002

(54) Bedside support apparatus

(76) Inventor: Steven R. Kammeyer, Troutdale, OR (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 09/778,305

(22) Filed: Feb. 6, 2001

(51) Int. Cl. A61G 7/10

(52) U.S. Cl. 5/81.1 R

(57) ABSTRACT

A bedside support apparatus is provided. The support apparatus typically includes a first handle portion configured to extend outward from a side of the bed and a second handle portion spaced apart from the side of the bed. The support apparatus further typically includes a frame configured to support the first and second handle portions, where the frame and first and second handle portions form a well sized to accommodate a wheelchair. The support apparatus also typically includes an elongate brace coupled to the frame and configured to attach to the near and far side of the bed. The elongate brace may be adjustable to clamp to the bed via opposed clamping members. The support apparatus may also be height adjustable to transfer weight from a near side of the bed to the frame.

### TECHNICAL FIELD

The present invention relates generally to support devices for wheelchair users, and more particularly to support devices to assist wheelchair users when getting into and out of bed from a wheelchair.

### BACKGROUND

Wheelchair users often have difficulty getting into and out of bed. The user typically wheels to the side of the bed and attempts first to stand from the wheelchair, and next to lie on the bed. To stand, the user often uses the arms of the wheel chair for support. However, standing with the support of the wheelchair is difficult because the arms are positioned low and behind the user as the user stands, and because the wheelchair may slide dangerously back and forth while the weight of the user is on the arms.

Once standing, it also is difficult for the user to transition from a standing position to a lying position on the bed. The wheelchair arms typically are too low to serve as a brace for the user during the transition. Consequently, the user may land on the bed in an uncontrolled manner, which may be unsafe and lead to injury.

It would be desirable to provide a bedside support apparatus for a wheelchair user for use in supporting the user when getting into and out of bed.

### SUMMARY OF THE INVENTION

A bedside support apparatus is provided. The support apparatus typically includes a first handle portion configured to extend outward from a side of the bed and a second handle portion spaced apart from the side of the bed. The support apparatus further typically includes a frame configured to support the first and second handle portions. The frame and first and second handle portions form a well sized to accommodate a wheelchair. The support apparatus also typically includes an elongate brace coupled to the frame and configured to couple to the near and far side of the bed, typically via a pair of coupling members. The elongate brace may include a length adjustment mechanism configured to enable the brace to clamp to the near and far side of the bed. The support apparatus also may be height-adjustable to transfer weight from a near side of the bed to the frame.

### BRIEF DESCRIPTION OF THE DRAWINGS

FIG. 1 is an isometric view of a bedside support apparatus according to one embodiment of the invention.

FIG. 2 is an isometric view of the bedside support apparatus of FIG. 1, showing a user transitioning from a sitting to a standing position.

FIG. 3 is an isometric view of a bedside support apparatus according to another embodiment of the invention.

FIG. 4 is a partial cross-sectional view of the bedside support apparatus of FIG. 3.

FIG. 5 is another partial cross-sectional view of the bedside support apparatus of FIG. 3, taken along line 5-5 of FIG. 4.

FIG. 6 is cross-sectional view of a length adjustment of a brace of the bedside support apparatus of FIG. 3.

### DETAILED DESCRIPTION OF THE PREFERRED EMBODIMENTS

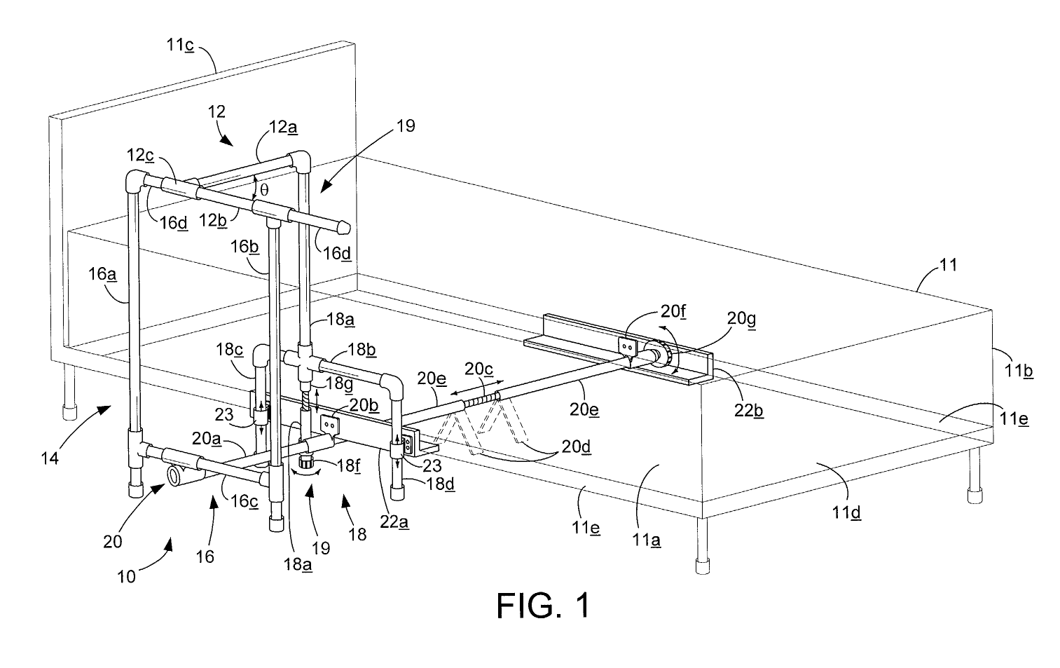

Referring initially to FIG. 1, a support apparatus according to one embodiment of the present invention is shown generally at 10. Support 10 is used next to an article of furniture 11, typically a bed 11, having a near side 11a and a far side 11b. Support 10 is used to enable a wheelchair user to transfer between a wheelchair and a bed.

Support 10 includes a handle 12, typically having first handle portion 12a and a second handle portion 12b, each configured to be gripped by a user. Handle portion 12a extends outward from near side 11a of bed 11. Typically, handle portion 12a is substantially perpendicular to the near side 11a of the bed 11. Alternatively, the handle may extend outward at an angle from the near side 11a of the bed 11. Because first handle portion 12a extends laterally outward from bed 11, it also may be referred to as a lateral handle portion 12a. Bed 11 may be described as having a lateral axis extending between the near side 11a and far side 11b of the bed, and a longitudinal axis extending between the head 11c and foot 11d of the bed.

Second handle portion 12b is spaced apart from the near side 11a of bed 11 and typically extends parallel to near side 11a of the bed. Alternatively, second handle portion 12b may be positioned in a non-parallel spaced apart orientation from bed 11. Because second handle portion 12b typically extends generally parallel to the longitudinal axis of the bed, it may also be referred to as longitudinal handle portion 12b. Second handle portion 12b is spaced apart from the bed, and therefore also may be referred to as a spaced apart handle portion 12b.

Typically, handle 12 is a united, L-shaped member that includes handle portions 12a and 12b, coupled by a T-joint 12c. Alternatively, the handle portions 12a, 12c may be formed in separate structures, may be formed integrally of a single piece of material, and/or may not be L-shaped or include a T-joint. For example, handle portions 12a, 12b may be formed on a curved member or V-shaped member.

Typically, handle portions 12a and 12b face each other, and are separated by a predetermined angle θ of less than about 180-degrees. According to one preferred embodiment of the invention, the predetermined angle θ is between about 60- and 120-degrees, and in a particularly preferred embodiment (shown) the angle is about 90-degrees, such that handle portions 12a and 12b are substantially perpendicular to each other.

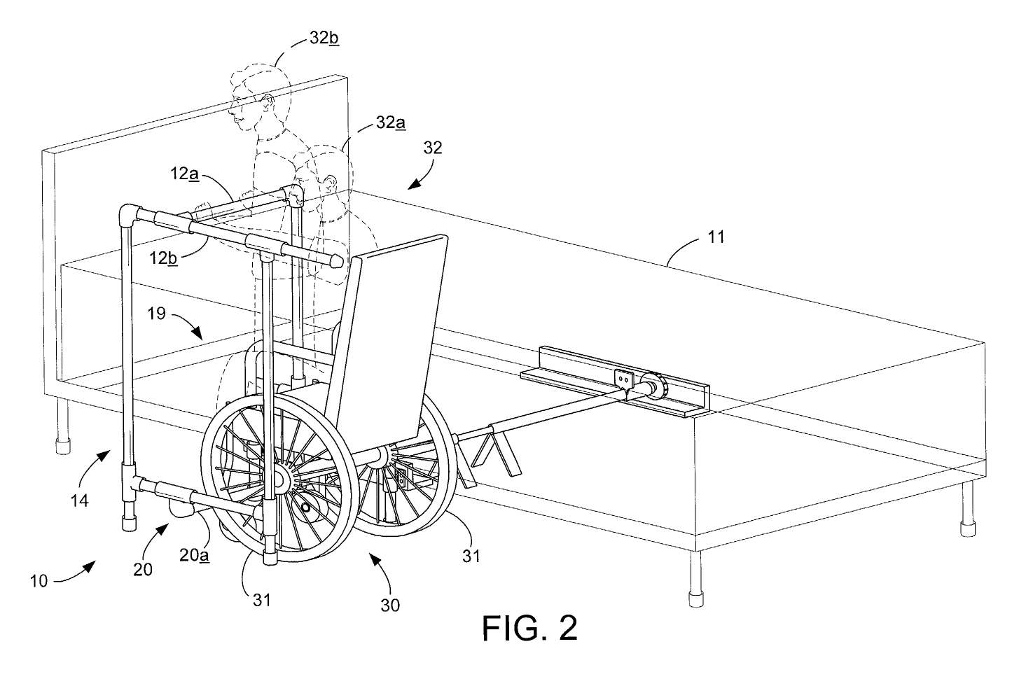

Support 10 further includes a frame 14 configured to support handle 12. Frame 14 typically includes an outer frame section 16 and an inner frame section 18, each of which bounds a void or well 19 into which a wheelchair 30, shown in FIG. 2, may be at least partially inserted. Well 19 is bound on a third side by handle 12a and an outwardly extending portion 20a of an elongate brace 20, described below. Well 19 also may be sized to fit a portable commode.

Outer frame section 16 typically includes a pair of spaced-apart vertical members 16a, 16b and a lower transverse member 16c extending between vertical members 16a, 16b. Vertical members 16a, 16b, are configured to contact the ground, typically a floor surface. Vertical members 16a, 16b are attached adjacent respective top ends to upper transverse member 16d, which includes longitudinal handle portion 12b.

Inner frame section 18 typically includes a vertical member 18a coupled adjacent an upper end to lateral handle portion 12a, and adjacent a middle portion to a transverse member 18b. Transverse member 18b, in turn, is coupled at each end to a pair of spaced-apart vertical members 18c, 18d. A lower end of vertical frame member 18a is coupled to a coupling member 22a via brace 20. Vertical members 18c, 18d are configured to contact the ground.

A lower portion of vertical frame member 18a includes a vertical adjustment mechanism 18g, which typically is adjustable via a handle or knob 18f. Vertical frame member 18a Upon rotation of knob 18f, the vertical adjustment mechanism 18g is configured to adjust the length of the lower portion of vertical member 18a, and spaced-apart vertical members 18c, 18d are configured to slide within guides 23. By such rotation, the user may adjust the amount of weight placed on spaced-apart vertical members 18b, 18c, to stabilize support 10, for example, during installation of support 10 on bed 11. Because vertical adjustment mechanism 18a transfers weight from near side 11a of bed 11 to outer frame section 16, it also may be referred to as a weight transfer mechanism 18a.

Support 10 also includes an elongate brace 20 coupled to frame 14 and configured to attach to the near side 11a and far side 11b of the bed 11. Typically, elongate brace 20 includes an outwardly extending portion 20a, which is attached to lower transverse member 16c of outer frame section 16. Outwardly extending portion 20a of elongate brace 20 extends outward from bed 11, and typically serves as a stop for wheels 31 of wheelchair 30 when the wheelchair rolls into well 19. Thus, outwardly extending portion 20a may also be referred to as a stop 20a. Stop 20a typically is positioned substantially directly below lateral handle 12a, although the stop alternatively may be placed in other positions suitable to stop the wheelchair.

Elongate brace 20 is coupled to a pair of opposed coupling members 22a, 22b, configured to attach to a frame 11e of bed 11. Typically, the coupling members 22a, 22b are L-shaped brackets, although another suitable form of coupling member may be used. Outwardly extending portion 20a of elongate brace 20 is configured to attach to coupling member 22a via mounting bracket 20b.

Elongate brace 20 also includes a crossing portion 20e having a length adjustment mechanism 20c configured to adjust the length of crossing portion 20e. Length adjustment mechanism 20c includes an internal screw and an associated handle or knob 20g positioned on the far side 11b of bed 11. Handle 20g is configured for direct digital manipulation. As handle 20g turns, the internal screw turns and adjusts the distance between the right and left sections of crossing member 20e. Thus, by rotating handle 20g, a user may lengthen or shorten crossing portion 20e of brace 20, to thereby adjust the position of coupling members 22a, 22b to fit frame 11e. By turning the knob tightly, the user also may clamp frame 11e between coupling members 22a, 22b. Brace 20 optionally further may include a pair of intermediate supports 20d coupled to far portion 20e on opposite sides of lateral adjustment mechanism 20c. Brace 20 is coupled to far side coupling member 22b via mounting bracket 20f.

Turning now to FIG. 2, a user 32 is shown using support apparatus 10. User 32 typically guides wheelchair 30 into well 19 until wheels 31 contact stop 20a. The user next grasps either or both of lateral handle 12a and longitudinal handle 12b for support, and transitions from a sitting position 32a to a standing position 32b. To lie on bed 11, the user rotates to face away from the bed, and slowly sits back onto the bed, all the while grasping either or both of handles 12a, 12b for support.

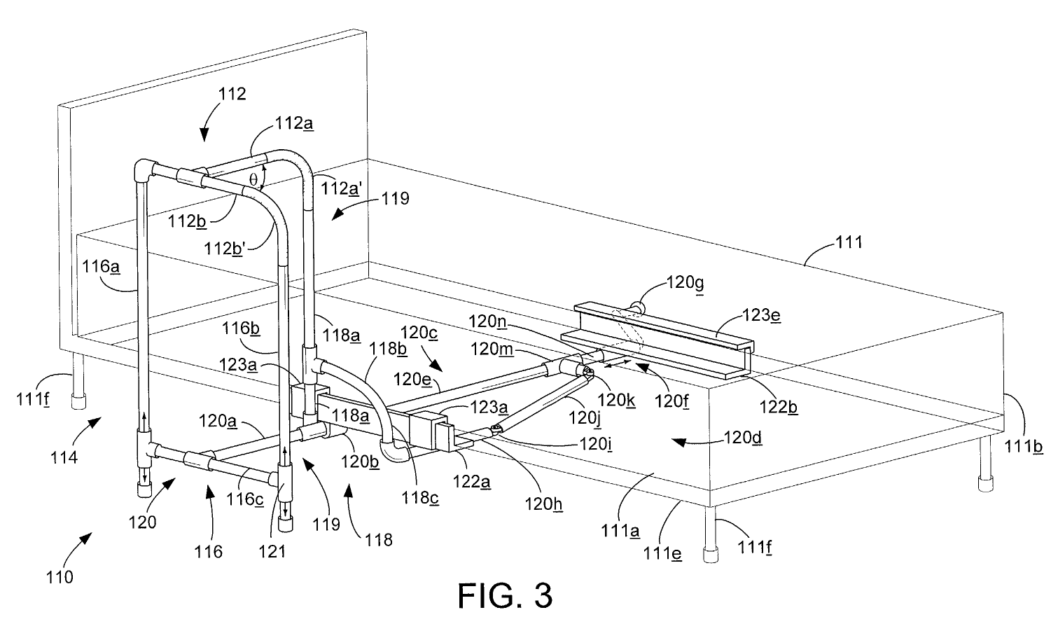

Turning now to FIG. 3, a bedside support apparatus according to another embodiment of the present invention is shown generally at 110 installed on a bed 111. Except where described differently below, the components of support 110 and bed 111 are similar to those described above for support 10 and bed 11, and are labeled with similar reference designators.

Support 110 typically includes first and second handle portions 112a, 112b oriented substantially perpendicularly to each other, and a frame 114 connected to each of the handle portions. Handles 112a and 112b typically include curved handle portions 112a′, 112b′, respectively. Typically curved handle portions 112a′, 112b′ are plastic, rubber, or foam-padded, although another material may be used. Alternatively, the handle portions may be positioned in other orientations, as described above. Frame 114 typically includes inner and outer frame sections 116, 118, which, along with handle portion 112a and elongate brace portion 120a, bound well 119. Frame section 116 includes spaced-apart upright vertical members 116a, 116b, which are connected adjacent a lower end by a lower transverse member 116c. The height of lower transverse member 116c may be adjusted by loosening fastener 121, to match the height of bed 11.

Inner frame section 118 includes a vertical member 118a connected adjacent a lower portion of the vertical member 118a to a curved member 118b. Unlike vertical member 18a described above, vertical member 118a is not typically length adjustable. Curved member 118b is linked to brace submember 120h, which in turn is attached to coupling member 122a. Vertical members 118a, 118b typically do not touch the ground. It will be noted that curved intersections 112a′, 112b′ exist between handle portion 112a and vertical member 116a, and between handle portion 112b and vertical member 116b. Curved intersections 112a′, 112b′ configured such that a user's hand may comfortably slide along their length. These curved intersections typically are rubber, plastic, or foam-padded, and may be considered part of handle portions 112a, 112b, as described above.

Support 110 further includes an elongate brace 120 coupled to lower transverse member 116a of the outer section 116 of frame 114, and to vertical member 118a of inner section 118 of frame 114. Elongate brace 120 is also configured to couple to the near and far sides of bed 111 via coupling members 122a, 122b.

As shown in FIG. 5, coupling member 122a typically includes a pair of clips 123a welded to a back side of the coupling member. Each clip typically includes an overhang portion 123b with an inwardly extending portion 123c and a downwardly extending portion 123d. As handle 125a is rotated, bolt 124a forces frame 111e against overhang portion 123b, preventing vertical movement of the frame 111e within the coupling member. Lateral movement of frame 111e within coupling member 122a is prevented by downwardly extending portion 123d. The frame 111e may be removed from coupling member 122a by rotation of the handle in a counterclockwise member.

Coupling member 122b typically includes an overhang potion 123e configured to rest against frame 111e to prevent downward movement of the brace relative to the frame 111e when installed. Typically, the space formed between overhang portion 123e and the lower horizontal portion of coupling member 122b is slightly larger than frame 116a, to allow for easy installation and removal. Once installed, the weight of brace 120 forces overhang 123e against the top of frame 111a. The horizontal spacing of the coupling members 122a, 122b may be adjusted using handle 120g, as described below.

Elongate brace 120 includes an outwardly extending portion 120a that spans frame 114, and a crossing portion 120c that spans bed 111. The crossing portion includes first and second cross members 120d, 120e. Second cross member 120d further includes submembers 120h, 120i, and 120m, coupled by pivoting joints 120i, 120k. Elongate brace 120 further includes a length adjusting mechanism 120f having a handle or knob 120g. As shown in FIG. 6, length adjustment mechanism 120f typically includes cross members 120n, 120o, and a handle 120g which turns to rotate screw 120p. As the handle is rotated, screw 120p turns freely within plug 120r, which is not threaded. Plug 120q, which is threaded, travels along the screw 120p as the screw is rotated, thereby causing length adjustment between cross member 120n and 120o.

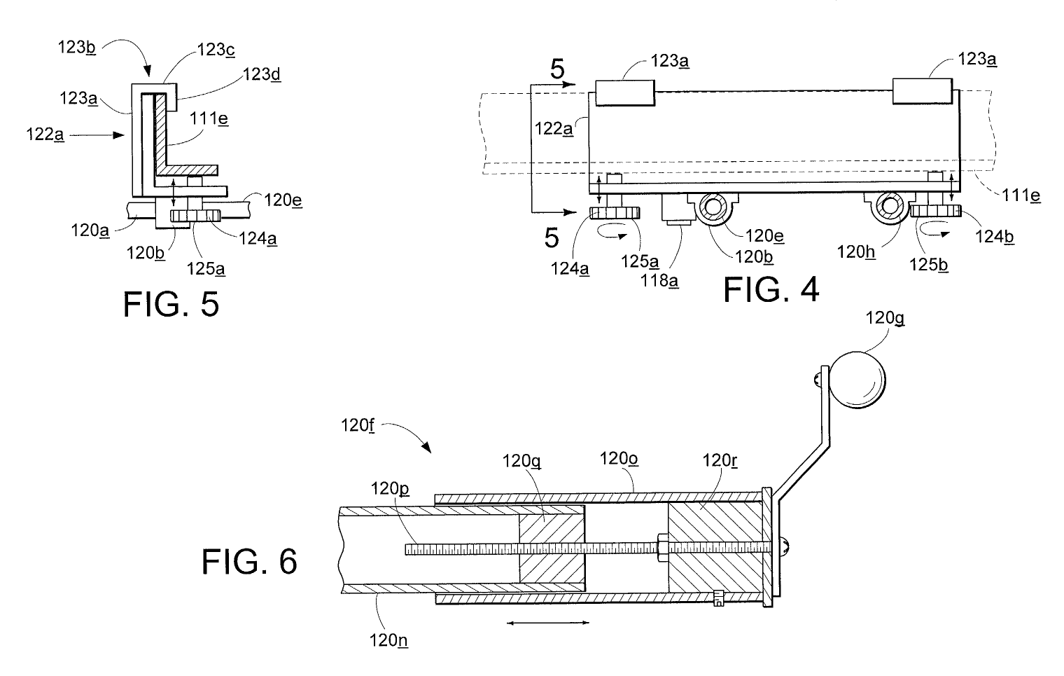

As shown in FIGS. 4-5, a portion of the weight from near side 111a of bed 111 may be transferred adjustably from bed legs 111f to outer frame section 116 by weight transfer mechanisms 124a, 124b, thereby to stabilize the support. Weight transfer mechanisms 124a, 124b typically are threaded bolts with handles 125a, 125b, provided for direct digital manipulation. Rotation of handles 125a, 125b causes the bolts to move upward, and causes weight from bed frame 111e to be transferred via the bolts, clamp 122a, brace 120, and handle 112, ultimately to outer frame section 116.

The above described embodiments of the present invention may be used by a wheelchair user to transition between a wheelchair and a bed in a safe and secure manner. It will be appreciated that the present invention may be used with an article of furniture 11, 111 other than a bed, such as a couch or chair.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

We claim:

1. A support apparatus for use in enabling a wheelchair user to transfer between a wheelchair and a bed, the bed having a near side and a far side, the support apparatus comprising:
a first handle portion configured to extend outward from a side of the bed;
a second handle portion spaced apart from the side of the bed;
a frame configured to support the first and second handle portions, where the frame and first and second handle portions form a well sized to accommodate a wheelchair; and
an elongate brace coupled to the frame and configured to attach to the near and far side of the bed.

2. The support apparatus of claim 1, wherein the second handle is positioned adjacent the first handle.

3. The support apparatus of claim 2, wherein the first and second handles are formed on a united member.

4. The support apparatus of claim 3, wherein the united member is L-shaped.

5. The support apparatus of claim 1, wherein the first and second handles are positioned at a predetermined angle relative to each other, the predetermined angle being between about 60 and 120 degrees.

6. The support apparatus of claim 5, wherein the predetermined angle is about 90 degrees.

7. The support apparatus of claim 1, wherein the first handle extends substantially perpendicularly outward from the near side of the bed.

8. The support apparatus of claim 1, wherein the second handle extends substantially parallel to the near side of the bed.

9. The support apparatus of claim 1, wherein the brace includes an outwardly extending portion and a crossing portion, the outwardly extending portion being configured to attach to the near side of the bed and the crossing portion being configured to attach to the far side of the bed.

10. The support apparatus of claim 9, further comprising a coupling member configured to couple the brace to a side of the bed.

11. The support apparatus of claim 10, wherein the coupling member is an L-shaped bracket.

12. The support apparatus of claim 9, further comprising a pair of opposed coupling members, each of the coupling members being configured to couple the brace to a frame of the bed.

13. The support apparatus of claim 9, wherein brace includes a length adjustment mechanism configured to adjust the length of the brace to accommodate a width of the bed.

14. The support apparatus of claim 13, wherein the length adjustment mechanism includes a handle configured to be actuated by direct digital manipulation and adjust the length of the brace.

15. The support apparatus of claim 14, wherein the handle extends outward from a far side of the bed.

16. The support apparatus of claim 1, wherein the brace includes an intermediate support positioned in between the near and far sides of the bed when installed, the intermediate support being configured to contact a ground surface.

17. The support apparatus of claim 1, wherein the frame includes an outer frame section spaced apart from the bed, the outer frame section having a vertical member configured to contact the ground.

18. The support apparatus of claim 17, further comprising a weight transfer mechanism configured to adjust the amount of weight placed on the outer frame section.

19. The support apparatus of claim 18, wherein the frame further includes an inner frame section adjacent the near side of the bed, and wherein the weight transfer mechanism is positioned within the inner frame section.

20. The support apparatus of claim 19, wherein the weight transfer apparatus includes a vertical adjustment mechanism configured to adjust the height of a vertical member of an inner section of the frame.

21. The support apparatus of claim 18, further comprising a near side coupling member configured to couple the frame to the near side of the bed, wherein the weight transfer mechanism is formed in the near-side coupling member.

22. The support apparatus of claim 21, wherein the weight transfer mechanism includes an adjustable bolt configured to contact a frame of the bed.

23. The support apparatus of claim 1, further comprising a stop coupled to the frame, the stop being configured to contact a wheel of the wheelchair and prevent forward movement of the wheelchair when the wheelchair is positioned in the well.

24. A support apparatus for use in enabling a wheelchair user to transfer between a wheelchair and a bed, the bed having a near side and a far side, the support apparatus comprising:
a first handle portion configured to extend outward from a side of the bed;
a second handle portion spaced apart from the side of the bed and extending generally parallel to the side of the bed, the first and second handle portions being positioned substantially perpendicularly to each other;
a frame configured to support the first and second handle portions, where the frame and first and second handle portions form a well sized to accommodate a wheelchair; and
an elongate brace coupled to the frame and configured to attach to the near and far side of the bed via a pair of opposed coupling members, wherein the brace includes a length adjustment mechanism configured to adjust the length of the bed to accommodate the width of the bed.

25. A support apparatus for use in enabling a wheelchair user to transfer between a wheelchair and an article of furniture, the article of furniture having a near side and a far side, the support apparatus comprising:
a first handle portion configured to extend outward from a side of the article of furniture;
a second handle portion spaced apart from the side of the article of furniture;
a frame configured to support the first and second handle portions, where the frame and first and second handle portions form a well sized to accommodate a wheelchair; and
an elongate brace coupled to the frame and configured to attach to the near and far side of the article of furniture.
